(19) United States
(12) Patent Application Publication
(10) Pub. No.: US 2024/0050899 A1
(43) Pub. Date: Feb. 15, 2024

(54) BYPASS CONTROL SLEEVE FOR SANITARY SPIRAL WOUND FILTER

(71) Applicant: BL TECHNOLOGIES, INC., Minnetonka, MN (US)

(72) Inventors: Travis Gerald STIFTER, Brooklyn Park, MN (US); Viadimir PAVLOVIC, Mississauga (CA); Michael WIMBERLY, Champlin, MN (US); Philip STAFFIN-WIEBE, Minneapolis, MN (US)

(21) Appl. No.: 18/547,660

(22) PCT Filed: Mar. 3, 2022
(86) PCT No.: PCT/US2022/018686

§ 371 Date: Aug. 23, 2023

Related U.S. Application Data
(60) Provisional application No. 63/157,387, filed on Mar. 5, 2021.

(51) Int. Cl. B01D 63/10

(52) U.S. Cl. CPC B01D 63/107; B01D 2313/08; B01D 2313/19

(57) ABSTRACT

A by-pass control sleeve has circumferential protrusions along its outer surface. The protrusions of the by-pass control sleeve may be distributed along the length of the sleeve with constant diameter sections of the sleeve therebetween. The protrusions may be asymmetrical and/or may have a steep and/or concave curved forward face. A method of making a by-pass control sleeve comprises molding the protrusions on an outer surface of the sleeve. A method of installing the by-pass control sleeve comprises sliding the sleeve onto an end of a spiral wound membrane element. A combination of the by-pass control sleeve fixed to the spiral wound membrane element may be installed in a pressure housing.

### FIELD

The present disclosure relates to spiral wound membrane elements, for example spiral wound membrane elements that can be used in sanitary applications.

### BACKGROUND

The following discussion is not an admission that anything discussed below is citable as prior art or common general knowledge.

Spiral wound membrane elements allow filtration or separation of a feed liquid. A feed liquid may contain, for example, dissolved or dispersed ions, organics, proteins, microorganisms and/or suspended solids. The spiral wound membrane element typically has several layers wound around a perforated central tube. Some of the wound layers form a membrane leaf comprising two halves of adjacent folded membrane sheets separated by an internal permeate collection material (permeate carrier sheet). A feed spacer sheet is disposed within the fold of each membrane sheet. Glue lines seal the permeate carrier sheet between adjacent membrane sheets along three edges of the membrane leaf. The fourth edge of the leaf remains open to the perforated tube. In use, the spiral wound membrane element separates the feed solution into a permeate (also known as a filtrate or effluent) and a concentrate (also known as a retentate or brine).

The spiral wound membrane element is housed in a pressure housing, also referred to as a pressure tube or pressure vessel. A pressurized feed liquid is delivered at an upstream end of the pressure housing and flows into the end of the spiral wound membrane element, specifically into the edges of the feed spacer sheets, and in some cases also around the outside of the element. Within the spiral wound membrane element, the pressurized feedstock flows through the feed spacer sheets and across the surface of the membrane sheets. The membrane sheets may have a separation layer that is suitably sized for microfiltration, ultrafiltration, nanofiltration or reverse osmosis. A portion of the pressurized feedstock is driven through the separation layer by transmembrane pressure to produce a permeate stream. The permeate stream flows along the permeate carrier sheets into the central perforated tube, then through the central tube to an outlet at the end of the pressure housing. The components of the pressurized feedstock that do not pass through the membrane, i.e. the retentate, continue to move through the feed spacer sheets to be collected at a downstream end of the pressure housing.

The outside diameter of the membrane element is typically smaller than the inside diameter of the pressure housing, for example by a few mm. An annular space exists between an inner surface of the pressure housing and the outer surface of the spiral wound membrane element. The annular space is an area of low flow, also referred to as tight tolerance. A portion of the feedstock can pass through the annular space. This is referred to as bypass flow. In areas of tight tolerance, there is limited fluid access and therefore limited flushing to remove solids or provide sanitization solutions. Increased bypass flow improves flushing of the annular space. However, the bypass flow also reduces the volume of feedstock that passes through the spiral wound membrane element to contribute to the production of permeate. In some cases, the membrane element has an impervious outer wrap and a brine seal between the outer wrap and the pressure housing to completely block or enclose the annular space to prevent bypass flow. While preventing bypass flow can improve permeate production by forcing more of the feedstock through the membrane element, feedstock may stagnate in the annular space. The annular space fluid may communicate with the feed channel through portions of the feed spacer being exposed to the annular space.

Some industries require spiral wound membrane elements that intentionally provide some bypass flow. For example, membrane elements in the dairy industry must meet the requirements of the Sanitary 3A Standards for Crossflow Membrane Modules. Meeting these standards requires some bypass flow to flush out the annular space. Membrane elements used in these industries are referred to as sanitary modules or sanitary elements. Some examples of sanitary elements are described in U.S. Pat. Nos. 5,985,146; 7,208,808; 8,668,828; and, 8,940,168. Sanitary modules also typically have a cage around the membrane leaves.

Typically, more than one spiral wound membrane element is housed in one pressure housing. For example, in the dairy industry five or six spiral wound membrane elements may be housed in one pressure housing. The central tubes of the membrane elements in a pressure housing are connected in series, and feedstock also passes through the membrane elements in a housing generally in series. In a complete system, there may be many pressure housings. The pressure housings are typically oriented horizontally on racks, which can reach heights of up to 10 m. From time to time, the membrane elements are removed from a pressure housing and replaced with new membrane elements. This is generally done by sliding membrane elements into and out of the pressure housing while the pressure housings remain installed in the racks. However, some brine seals can make it difficult to slide membrane elements into or out of a pressure housing.

### SUMMARY

This disclosure describes a by-pass control sleeve for a spiral wound membrane element, a method of making a by-pass control sleeve and a method of installing a by-pass control sleeve. The outer surface of the by-pass control sleeve may have one or more of asymmetric protrusions, protrusions separated by constant diameter segments, and protrusions with a steep or concave forward face. In at least some examples, the by-pass control sleeve provides a sufficient turbulence to provide sanitary conditions in the annular space around the by-pass control sleeve with low by-pass flow. The by-pass control sleeve may be provided along only part of the length of the spiral wound element at one or both ends of the spiral wound element. The by-pass control sleeve may be pre-molded material to provide the protrusions and slid onto the ends of the spiral wound element.

### BRIEF DESCRIPTION OF THE FIGURES

FIG. 1A shows a cross section of part of a prior art by-pass control sleeve design with radiused peaks.

FIG. 1B shows a cross section of part of a prior art by-pass control sleeve design with triangular peaks.

FIG. 2 shows part of the surface of a novel by-pass control sleeve having an asymmetric peak, a steep and concave front face of the peak, and valleys separating the peaks, optionally called an asymmetric peak or curved peak sleeve.

FIG. 3A shows a by-pass control sleeve as in FIG. 2 fixed to ends of a spiral wound membrane element.

FIG. 3B shows a by-pass control sleeve as in FIG. 2 extending along the full length of a spiral wound membrane element.

FIG. 4 is a flow rate comparison graph between prior art by-pass control sleeves (triangle and radiused) and a by-pass control sleeve (curved peak) as in FIG. 2.

FIG. 5 is a comparison of cell Reynolds number determined by computational fluid dynamics showing flow velocities of prior art by-pass control sleeves (triangle and radiused) and a by-pass control sleeve (curved peak) as in FIG. 2.

FIG. 6 is a schematic drawing of a by-pass control sleeve test system.

FIG. 7 is a graph depicting feed flow at specified pressure drops for spiral wound membrane modules having a triangle peak sleeve and a curved peak sleeve.

FIG. 8 is a graph of housing flow in gpm to gallons of RO permeate produced, at 10 psid, for each of the triangle peak shell and the curved peak shell.

FIG. 9 is graph of recirculation pump power in kW to % Brix of the feed solution for each of the triangle peak shell and the curved peak shell.

### DETAILED DESCRIPTION

A spiral wound membrane element with a by-pass control sleeve, which may also be referred to as a by-pass control ring, is described herein. The by-pass control sleeve is a sleeve adapted to fit around a spiral wound membrane element. The by-pass control sleeve disrupts the flow of feedstock in the annular space between the outside of the spiral wound membrane and the inside walls of the pressure vessel. Disrupting the flow of feedstock outside of the element creates turbulence to help clean the annular space and reduce the overall bypass flow rate.

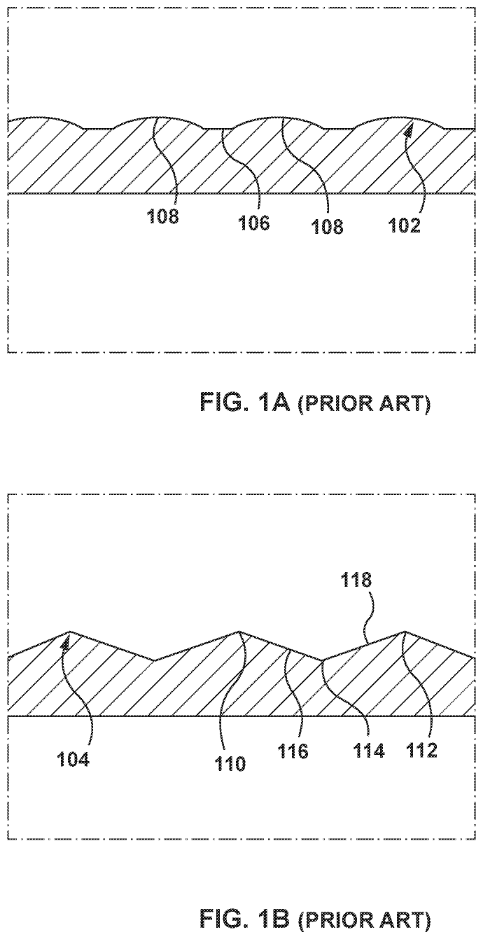

FIGS. 1A and 1B show portions of prior art by-pass sleeve or ring designs with protrusions. FIG. 1A shows protrusions having a radiused or convex rounded peak design 102, while FIG. 1B shows protrusions having a pointed or triangle peak design 104. Both prior art designs provide symmetrical peak shapes. The FIG. 1A radiused peak design 102 has short valleys 106 between adjacent protrusions, where a valley comprises a section of the sleeve that has a constant diameter along its width. The valleys 106 of the radiused peak design have widths that are less than 50% of the width of the protrusions 108. The FIG. 1B design includes adjacent protrusions 110, 112 that meet at a point 114 such that the end of a downstream side 116 of the first protrusion 110 is the start of an upstream side 118 of an adjacent protrusion 112. The FIG. 1B design does not have significant valleys (i.e. sections of constant diameter) between adjacent protrusions.

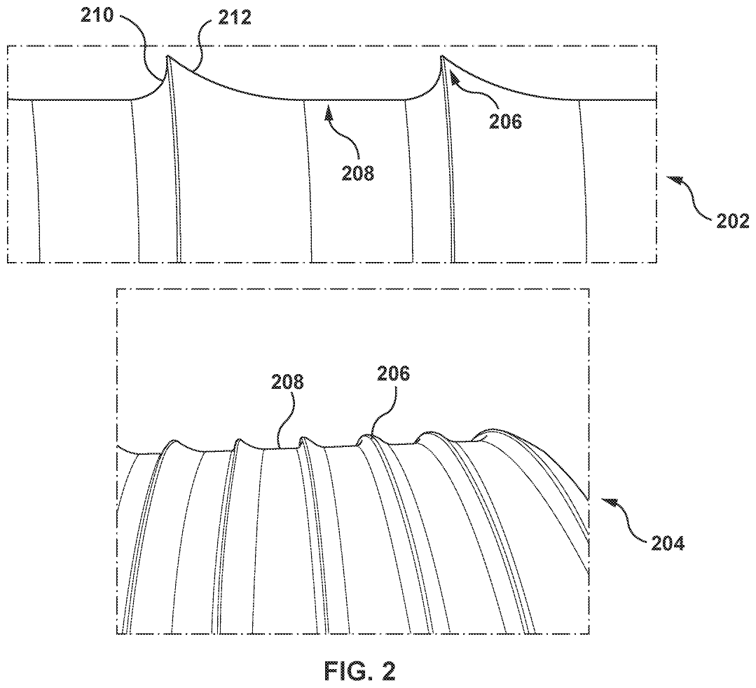

FIG. 2 shows an example first by-pass control sleeve 202 and an example second by-pass control sleeve 204 differing mainly in their relative dimensions. Each by-pass control sleeve may have discrete protrusions or ridges 206 with valleys 208 between the protrusions. The ridges and valleys extend around the circumference of the sleeve. The ridges may extend around the circumference in repeating discrete circles or in a helical or spiral pattern along the length of the sleeve. The valleys and ridges may be disposed along the entire length of the sleeve or only a portion of the sleeve. The valleys 208 may have an essentially constant diameter (i.e. varying by 1 mm or less) along the width of the valley. The width of a valley 208 may be in the range of 50-200% of the width of a ridge 206.

Each ridge 206 comprises an upstream side 210 and a downstream side 212. The upstream side comprises a forward face that may include as a steeply slope or concave curved portion. In an example, the curve of the forward face of the ridge may end at a peak while pointing substantially vertically, or normal to the circumference of the sleeve. As liquid flows along the upstream side of the ridge 206, the liquid may be deflected radially outwards. The radial liquid deflection may increase turbulence and disrupt or slow down the feed flow passing in the annular space between the inside of the pressure vessel and the sleeve.

In the examples of FIG. 2, the downstream side of each ridge is different, i.e. longer, less steeply sloped and/or more gently curved, than the upstream side of the ridge such that the ridge is asymmetrical. In some examples of asymmetrical ridges, the rear face may be curved, for example with a concave curve, but with less steep initial slope and/or a larger radius of curvature relative to the forward face. In some examples, the rear face may be continuously curved. The length, slope and/or curvature of the downstream side may inhibit the formation of eddies. Particularly when eddies are minimized, water follows the downstream side of the ridge. Flowing water is hereby pulled downwards into the valley. The water flowing in the valley is diverted upwards by the upstream side of the ridge, and disturbs the flow of water in the annular space between the inside of the pressure vessel and the sleeve.

The sleeves 202, 204 shown in FIG. 2 include asymmetric ridges 206 with valleys 208 disposed between them. A distal (i.e. radially outward) end of the forward face 210 of each ridge 206 has a concave curve or steep positive slope while a distal end of the rear face 212 also has a concave curve or negative slope. In this way, the forward face 210 and the rear face are connected by a generally sharp peak, transition or discontinuity in slope. The downstream side or rear face 212 of each ridge 206 may have a gradual, nearly linear slope from the peak of the ridge to a curve that ends at abutting valley, or a continuous concave curve between the peak and the valley. In some examples, the ridges along the length of the sleeve may have the same width and the valleys along the length of the sleeve may have the same widths. In other examples, the width of the ridges and/or the valleys may vary along the length of the sleeve.

The space between the top of each peak of the sleeve and the inside of the pressure vessel may be between 0.02 and 0.2 cm (0.008-0.08 inches).

The distance between peaks of adjacent ridges may be between about 0.2 cm to about 1.6 cm (0.08-0.6 inches).

The depth of the valleys between adjacent ridges may be between about 0.02 cm to 0.3 cm (0.008-0.12 inches). The depth of valley is the distance between the peak height and the floor of the valley.

The bypass control sleeve according to the present disclosure has an inside diameter compatible with the outside diameter of the spiral wound membrane element. The by-pass control sleeve may have a length of 400 mm (16″) or less, or 350 mm (14″) or less, or 300 mm (12″) or less, or 250 mm (10″) or less, or 200 mm (8″) or less, or 150 mm (6″) or less. The by-pass control sleeve may have a length of 100 mm (4″) or more. In another example, the by-pass control sleeve may have a length that spans substantially the full length of the spiral wound membrane element. Each spiral wound membrane element, or series of elements in a pressure vessel, is preferably fixed with at least one by-pass control sleeve, for example on the downstream end of the spiral wound membrane. The spiral wound membrane element, or series of elements, may alternatively or in addition be fixed with a by-pass sleeve at an upstream end of the element or series of elements. Two or more by-pass control sleeves may be used. For example, a by-pass control sleeve may be fixed at the upstream end of a membrane element and another at the downstream end of the membrane element. In another example, a by-pass control sleeve may be fixed on each end, and one or more sleeves may also be positioned along the length of the spiral wound membrane element. One or more sleeves may span a portion of or the entire length of a spiral wound membrane element. In an example where several spiral wound membranes are connected in series within the same pressurized vessel, each spiral wound membrane element may be fixed with one or more by-pass sleeves before being placed in series within the pressurized vessel.

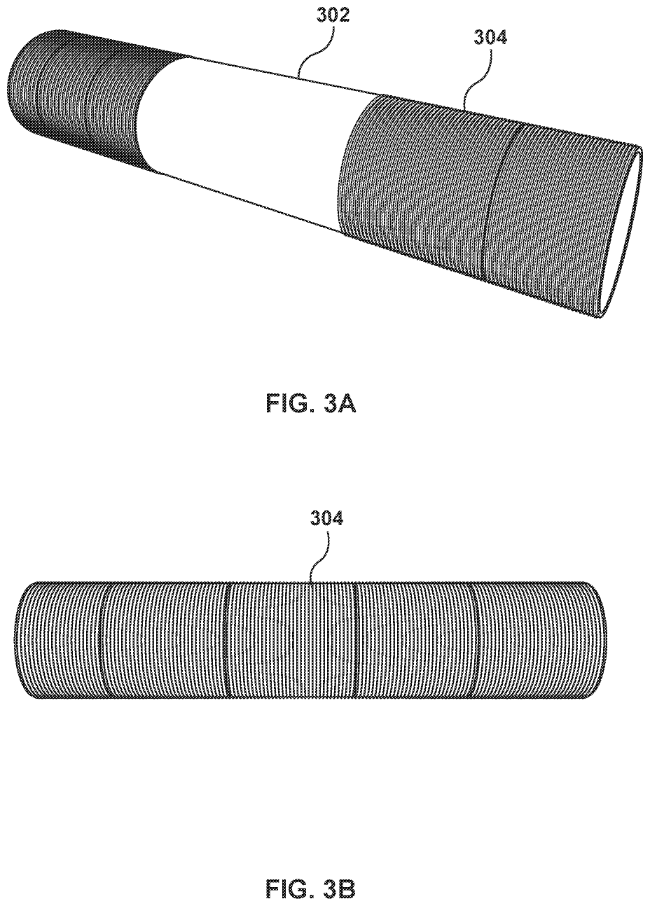

FIGS. 3A and 3B show examples of a spiral wound membrane elements 302 with multiple by-pass control sleeves 304. FIG. 3A shows by-pass control sleeves affixed to the upstream end and the downstream end of the spiral wound membrane. In the example shown, multiple by-pass control sleeves 304 are placed on each end of the spiral wound membrane element 302. Alternatively, a single by-pass control sleeve 304 of the same total length as the multiple sleeves 304 shown may be used. FIG. 3B shows a spiral wound membrane element 302 with by-pass sleeves 304 extending substantially along its entire length. Alternatively, one longer sleeve 304 may be used to cover the full length of the element.

In use, part of the feed flowing in the annular space flows above the peaks of the sleeve while the rest of the feed flowing in the annular space contacts the steeply curved upstream side of the ridge and becomes radially deflected towards the portion of the feed flowing above the peaks. This causes turbulence in the annular space, slowing down and restricting the amount of flow past the outside of the element. Less flow past the element allows more of the feed to pass through the element and contributes to an increase in product recovery. The turbulence may also contribute to scouring the annular space to help prevent solid build up or bacteria growth in the space.

The bypass control sleeve according to the present disclosure may be made of a plastic or other material. The bypass control sleeve can be, for example, molded or machined. Examples of suitable materials that are accepted for food contact include thermoplastic polymers such as: polypropylene, polyethylene (PE), low density polyethylene, high density polyethylene, ultra high molecular weight polyethylene (EIHMWPE), polyvinylidene fluoride, polytetrafluroethylene, and thermopastic polyurethanes. Other suitable materials that are accepted for food contact include elastomers, fluroelastomers, and thermosetting polyurethanes. Heat shrink materials, such as Raychem Semi Rigid Modified Polyolefin, are other examples of suitable materials for the bypass control sleeve. A semi-rigid heat shrink material may be molded to form the bypass control sleeve. Optionally, the bypass control sleeve could be made of a material such as nylon, ABS, polyethersulfone, polyetheretherketone, polyetherimide or stainless steel. The bypass control sleeve can be made of a low friction material such as PE or UHMWPE, for example material having a low coefficient of friction with stainless steel or fiberglass. The bypass control sleeve can be made of an elastomer (such as ethylene propylene diene methylene rubber (EPDM), silicone rubber, or nitrile butadine rubber) or a fluoroelastomer (such as a copolymer of at least hexafluoropropylene (HFP) and vinylidene fluoride (VDF or VF2); a terpolymer of at least tetrafluoroethylene (TFE), vinylidene fluoride (VDF or VF2) and hexafluoropropylene (HFP); or a copolymer of at least tetrafluoroethylene (TFE) and perfluoromethylvinylether (PMVE)). The fluoroelastomer may have a fluorine content from about 66 to about 70%. The fluoroelastomer may be categorized under the ASTM D1418 and ISO 1629 designation of FKM, and may be sold under the name Viton™. Bypass control sleeves made of elastomers or fluoroelastomers may have a high coefficient of friction with stainless steel or fiberglass. A lubricant, such as glycerin, may be used to help insert a bypass control sleeve made of an elastomer or fluoroelastomer. The lubricant may be removed, such as by rinsing the lubricant away, after the bypass control sleeve is inserted.

The bypass control sleeve can be heated to cause it to expand and increase its inside diameter for installation. The heated bypass control sleeve can then be slipped over the end of the spiral wound membrane element and allowed to cool. As it cools, the bypass control sleeve shrinks to provide a tight fit onto the spiral wound membrane element. Optionally, the bypass control sleeve, when cooled, has an inside diameter that is smaller than the end of the spiral wound membrane element. This helps retain the bypass control sleeve in place on the spiral wound membrane element and may also compress the spiral wound membrane element. Alternatively, the bypass control sleeve can be stretched without yielding it. In this case, the stretched bypass control sleeve is placed over the element and then released, allowing the bypass control sleeve to elastically contract to its original size, which may provide a snug fit against the element or compress the element. In another alternative, when the bypass control sleeve is formed from a heat shrink material, the bypass control sleeve can be placed over the spiral wound membrane, and heated to cause it to shrink. The heat-shrink material and the size of the bypass control sleeve are selected so that the shrinking provides a tight fit onto the spiral wound membrane element. Optionally, the bypass control sleeve, when shrunken, has an inside diameter that is smaller than the end of the spiral wound membrane element. This helps retain the bypass control sleeve in place on the spiral wound membrane element and may also compress the spiral wound membrane element. One example of a heat shrink material that may be used is Raychem Semi Rigid Modified Polyolefin, which has a 250% (min.) ultimate elongation and shrinks at temperatures above 125° C., such as at temperatures of about 150° C.

The bypass control sleeve may compress the element sufficiently to reduce the circumference of the element by an amount from about 0.2 to about 0.4 cm. The bypass control sleeve may compress against the element with sufficient force to: keep the bypass control sleeve in place, prevent the feed channel from opening up, prevent the element from telescoping, or any combination thereof, during standard operating conditions, which may include contact with elevated temperature feed streams. For example, the bypass control sleeve may sufficiently compress the element such that the compressive force, in combination with the underlying coefficient of friction and the interference due to the structure of the bypass control sleeve, is greater than the applied force pushing the bypass control sleeve downstream. For a bypass control sleeve having a cross sectional area of 3.5″ squared and facing a pressure drop of 15 psi, for example, the applied force pushing the control sleeve downstream is about 52.5 lbs.

The outside diameter of the bypass control sleeve may be initially slightly more or less than the inside diameter of a pressure housing. If slightly more, or if the bypass control sleeve remains stretched when installed on the spiral wound membrane element, the outer diameter of the bypass control sleeve can be reduced after the bypass control sleeve is installed but before or as the spiral wound membrane element is inserted into a pressure housing. For example, the bypass control sleeve can be machined or thermally modified (i.e. remolded) to reduce its diameter. In another option, the bypass control sleeve is compressed as it is placed in the pressure housing, for example in a fixture that the spiral wound membrane element slides through or against the pressure housing itself. The elements with bypass control sleeves may have forces required to insert them into a housing, slide them in a housing and/or remove them from a housing that is equal to or less than, for example at least 10% less, at least 20% less or at least 30% less, than forces required for existing caged sanitary elements and/or shelled sanitary elements, for example the Dow Hypershell™ RO8038 or the Suez AF8038 sanitary RO module.

Optionally, one or more additional bypass control sleeves can be placed at one or more locations along the length of the spiral wound membrane element. A bypass control sleeve, being relatively rigid and optionally pre-stressed, can help resist expansion or unwinding of the spiral wound membrane element during filtering operations or sanitization procedures. However, it is expected that one bypass control sleeve on the downstream end of a spiral wound membrane module will be sufficient.

Table 1 below shows the results of a computational fluid dynamics (CFD) analysis comparing by-pass flow rates at a pressure differential of 68.95 kPa (10 psi) for the radiused peak design of FIG. 1A, the triangle peak design of FIG. 1B and a curved peak (i.e. asymmetric) design according to the examples shown in FIG. 2. The peak-to-wall distance for each of the designs in the analysis was 0.1 cm (0.04 inches). As seen in the table, the curved peak design shows an improvement (i.e. a reduction in by-pass flow rate) over the two prior art examples. At a pressure differential of 68.95 kPa, the sleeve according to FIG. 2 showed about a 20% improvement over the triangle peak shape and about a 60% improvement over the radiused peak shape.

TABLE 1
Comparison of Curved Peak (Asymmetric)
Design with Prior Art

| | Radiused | Triangle | Curved |
|---|---|---|---|
| | Peak | Peak | Peak |
| Change in | 68.95 kPa | 68.95 kPa | 68.95 kPa |
| Pressure | (10 psi) | (10 psi) | (10 psi) |
| Peak-to-Wall | 0.1016 cm | 0.1016 cm | 0.1016 cm |
| | (0.04 inches) | (0.04 inches) | (0.04 inches) |
| Peak-to-Peak | 0.508 cm | 0.635 cm | 0.508 cm |
| | (0.20 inches) | (0.25 inches) | (0.20 inches) |
| Depth of Valley | 0.0508 cm | 0.1143 cm | 0.01143 cm |
| | (0.02 inches) | (0.045 inches) | (0.045 inches) |
| Flow Rate | 213.61 l/min | 155.88 l/min | 126.96 l/min |
| | (56.43 gpm) | (41.18 gpm) | (33.54 gpm) |

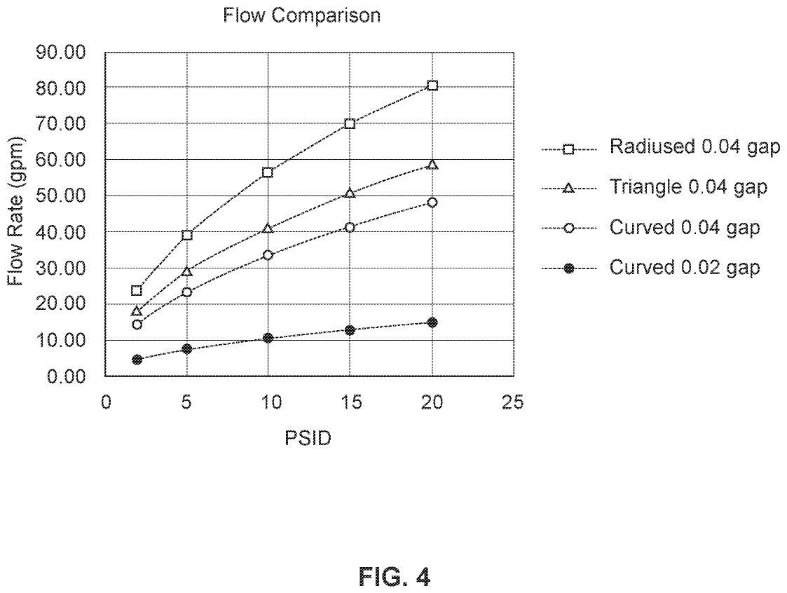

FIG. 4 shows a graph comparing flow rates in gallons-per-minute as the change in pressure increases for the three above mentioned designs with a 0.1016 cm (0.04 inch) peak to wall gap (distance from the peak to the inside of the pressure vessel), and an additional curved (asymmetric) sleeve design with a 0.05 cm (0.02 inch) peak to wall gap.

The reduction in by-pass flow attributed to the curved sleeve design may help increase the recovery rate of a filtration process. Without being bound by theory, it is hypothesized that an asymmetric peak design with a steep forward face, for example as shown in FIG. 2, provides increased turbulence, and thereby reduces the by-pass flow, relative to the radiused or triangle peak shapes.

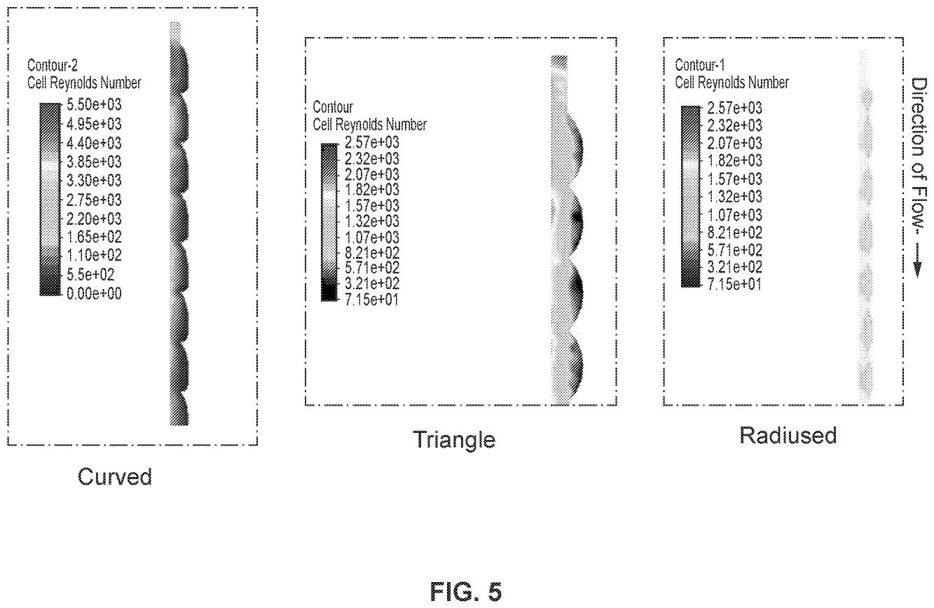

FIG. 5 shows the results of CFD modeling experiments showing the Reynolds number of the by-pass flow around sleeves having curved (asymmetric), triangular and radiused ridges with the same flow and peak-to-wall distance. As shown in the FIG. 5, the flow in the values of the curved (radiused) sleeve includes laminar flow. Without intending to be limited by theory, the inventors believe that flowing water is pulled into the valleys of the curved (asymmetric) sleeve, which decreases the by-pass flow.

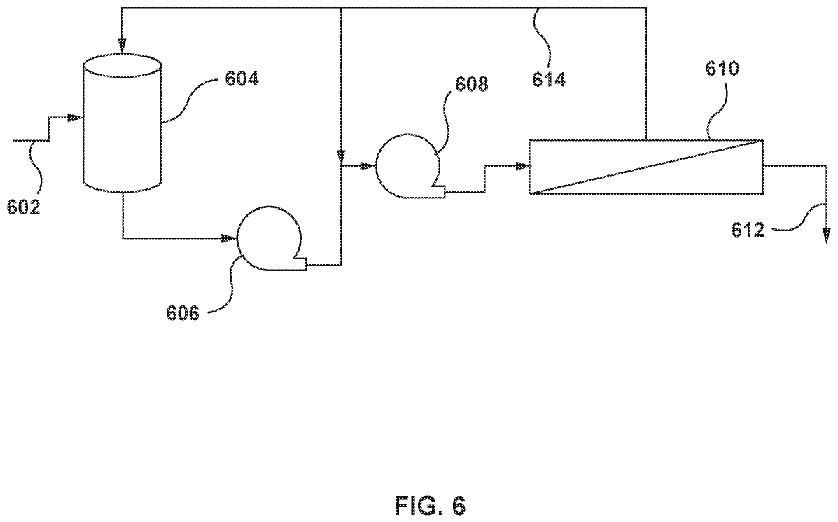

FIG. 6 is a schematic showing an example test system using a caged spiral wound RO membrane element with a by-pass control sleeve module 610, having either a curved peak design or a triangle peak design in different tests, around the spiral wound membrane element. Ultrafiltration permeate (UF permeate) 602 from an upstream process, for example from a sweet whey or acid whey process, may be used as feed to the test system and added to the feed tank 604. The UF permeate may then be pumped via a feed pump 606 and a recirculation pump 608 towards the module 610. Permeate 612 is expelled from the system while concentrate 614 is partially returned to the feed tank 604 and partially recirculated via the recirculation pump 608 back to the module 610. A baseline pressure is determined at the outlet of the feed pump. The recirculation pump boosts the pressure to control the flow through the module 610. The pressure drop of the system is determined as the difference in pressure between the boost pressure and the baseline pressure (i.e. the pressure differential between the inlet and outlet of the recirculation pump 608) which is the same as the pressure difference between the inlet of the element and the concentrate outlet of the element. In an example, 75-77% of the concentrate 614 is recirculated to the element and 23-25% of the concentrate 614 is returned to the feed tank 604. In an example system, a control valve (not shown) is configured to adjust the concentrate flow between the feed tank return portion and the recirculated portion. In an example system, a heat exchanger may be disposed in the path between the recirculated concentrate and the feed tank such as to control the temperature of the system to approximately 12-16° C.

In an example test, a by-pass control sleeve with a curved peak according to the present disclosure (similar to the second by-pass control sleeve 204 of FIG. 2) was compared with a Dow Flimtec™ Hypershell™ RO8038 having a by-pass control sleeve similar to the triangle peak design 104 of FIG. 1B (triangle peak). The triangle peak sleeve around the element comprised a one-piece sleeve with a length of 38 inches (965.2 mm), and a circumference of 633.5 mm at one end, 634.5 mm at a middle portion, and 634.5 mm at a second end. The curved peak design by-pass sleeve set-up comprised two by-pass control sleeve segments with the curved peak profile. The two sleeve segments were placed at opposite ends of an element. The same type of membrane element was used with both the curved peak by-pass sleeve and the triangle peak by-pass sleeve. The curved peak by-pass control sleeve segments each measured 13.5 inches in length and had a circumference of 633 mm. The element measured 38 inches in length with the by-bass control sleeve segments covering 13.5 inches of each end leaving a middle caged portion of the element of about 11 inches exposed. The exposed caged element between the sleeves had a circumference of 621 mm. Table 2 sets out the additional parameters of each of the triangle peak and the curved peak by-pass control sleeve used in this test, each being housed in an 8 inch diameter housing.

TABLE 2
Parameters of triangle peak and
curved-peak by-pass sleeve

| | Triangle | Curved |
|---|---|---|
| | Peak | Peak |
| Peak-to-Wall | 0.022 inches | 0.032 inches |
| Peak-to-Peak | 0.250 inches | 0.200 inches |
| Depth of Valley | 0.045 inches | 0.045 inches |

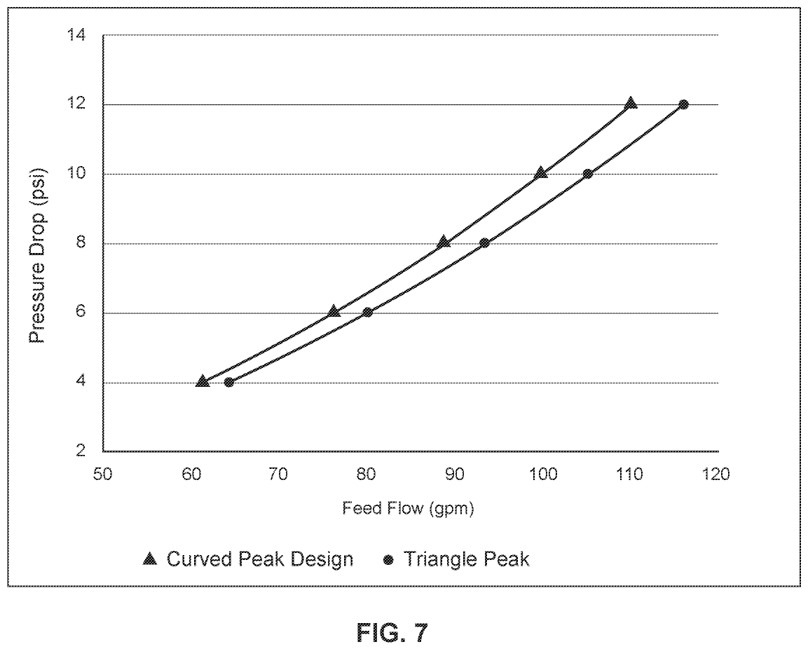

In order to achieve an optimized pressure drop through the element, for example between 8-12 psid, based on a given flow rate, typically the recirculation pump is required to expend more energy to increase the flow rate of the feed (where the feed includes the feed from the feed tank and the recirculated concentrate), to achieve the required pressure drop. In an example pure water test comparing the above triangle peak and curved peak by-pass sleeve, a 4.5% decrease in housing flow resulting from the curved peak design as compared to the triangle peak provided an average of 4.4% power reduction on the recirculation pump. FIG. 7 shows a graph depicting the feed flow at specified pressure drops for each of the triangle peak and the curved peak design set-ups as described above. As shown in the graph, the feed flow through the housing having the curved peak design is less at a given pressure drop as compared to the triangle peak at the same pressure drop. Table 3 shows the reduction in flow rate in a system with the curved peak by-pass sleeve compared to a system with the triangle peak and the corresponding reduction in power of the recirculation pump for a given pressure drop.

TABLE 3
Comparison of power and flow rate of curved
peak by-pass control sleeve realtive to
triangle peak by-pass control sleeve

| | Recirculation | Recirculation |
|---|---|---|
| | Pump | Flow |
| Pressure Drop | Power | rate |
| (psi) | (kW) | (gpm) |
| 8 | −4.0% | −4.5% |
| 10 | −4.2% | −4.6% |
| 12 | −5.1% | −4.4% |

The above results compared a curved-peak by-pass control sleeve having a 633 mm circumference to a triangle peak control sleeve having between 633.5 mm to 634.5 mm circumference, as previously indicated. CFD modeling was conducted to determine flow rates using the curved peak by-pass sleeve at circumferences from 630.07 mm to 634.86 mm. The CFD model assumes an 8-inch long by-pass control sleeve in a housing having an 8-inch inner diameter. All other parameters of the by-pass control sleeve were fixed such that only the peak-to-wall gap changed between tests. The CFD model results depicted in Table 4 below show the effect of increasing the peak-to-wall gap up to approximately the same peak-to-wall gap of the triangle peak sleeve used in the tests described above. Based on the decreased flow rates seen in Table 4, an even greater response to energy performance is expected when the curved peak by-pass control sleeve set-up comprises a peak-to-wall distance that is the same as or closer to the peak-to-wall distance of the triangle peak sleeve.

TABLE 4
CFD modeling results with changes in peak-to-wall
distance of curved peak by-pass control sleeve

| | | | | Flow at |
|---|---|---|---|---|
| Circumference | Peak to | Peak to | Depth of | 10 psid |
| (mm) | Peak | Wall | Valley | (gpm) |
| 634.86 | 0.2 | 0.02 | 0.045 | 9.38 |
| 634 | 0.2 | 0.025 | 0.045 | 13.34 |
| 633.22 | 0.2 | 0.03 | 0.045 | 17.87 |
| 631.99 | 0.2 | 0.04 | 0.045 | 32.25 |
| 630.07 | 0.2 | 0.05 | 0.045 | 44.17 |

In another example test, 140 gallons of UF permeate were added to the system in place of the pure water. A feed tank with a capacity of 140 gallons may be used, however in a particular example, the feed tank capacity of less than 140 gallons was used and the UF permeate was added in increments of 1 gpm. As 1 gpm of RO permeate exited the system from the element, 1 gpm of feed was added to the feed tank until 140 gallons of feed in total were introduced to the system, at which point no more fresh feed was added to the feed tank. Concentrate from the element continued to be recirculated back to the feed tank until the UF permeate was concentrated from approximately 4% Brix up to approximately 20% Brix, for example from approximately 4.5% Brix to approximately 18.5% Brix, at which point the test was concluded. During the batch processing of 140 gallons of UF permeate, the two element set ups being compared were run at 10 psid throughout the duration of the test and the feed pressure was adjusted to maintain a set permeate flow rate. Both were run for approximately 130 minutes and concentrated up the feed (UF permeate) from ˜4% Brix to 18.5% Brix. In an example where the feed contains lactose, the starting feed has approximately 4.5% lactose which is then concentrated up to about 20% lactose by the end of the trial.

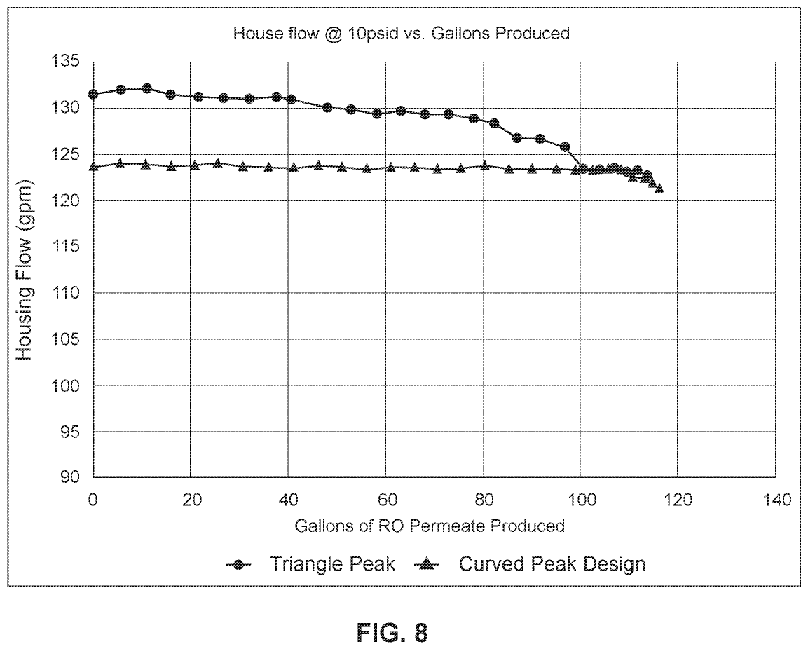

FIG. 8 is a graph of housing flow in gpm to gallons of RO permeate produced, at 10 psid between the inlet and outlet of the recirculation pump 608, for each of the triangle peak sleeve and the curved peak sleeve. The housing flow was measured between the recirculation pump and the entrance of the element. As the RO permeate increases, the UF permeate feed becomes more concentrated due to the recirculation of concentrate back to the feed tank. As seen in FIG. 8, the curved peak by-pass sleeve maintained a lower flow rate as compared to the triangle peak sleeve as the RO permeate increased up to about 100 gallons, at which point the flow rates of both systems converged to about the same. The results show that the curved peak design provides a significant improvement over the triangle peak design during early stages of UF permeate processing, particularly when the UF permeate concentration is in the range of 4.5%-15% Brix. For example, the curved peak design shell provided a 6% reduction in required housing flow and a corresponding 8.4% power reduction as compared to the triangle peak sleeve. When the concentration increased to between 15% and 20% Brix for example, the two systems provide similar results, although the curved peak still provided slightly improved results with a ≤0.5% reduction in the required housing flow and a corresponding ≤1.7% power reduction compared to the triangle peak sleeve. The triangle peak sleeve may be more dependent on the viscosity of the feed as compared to the curved peak design by-pass shell.

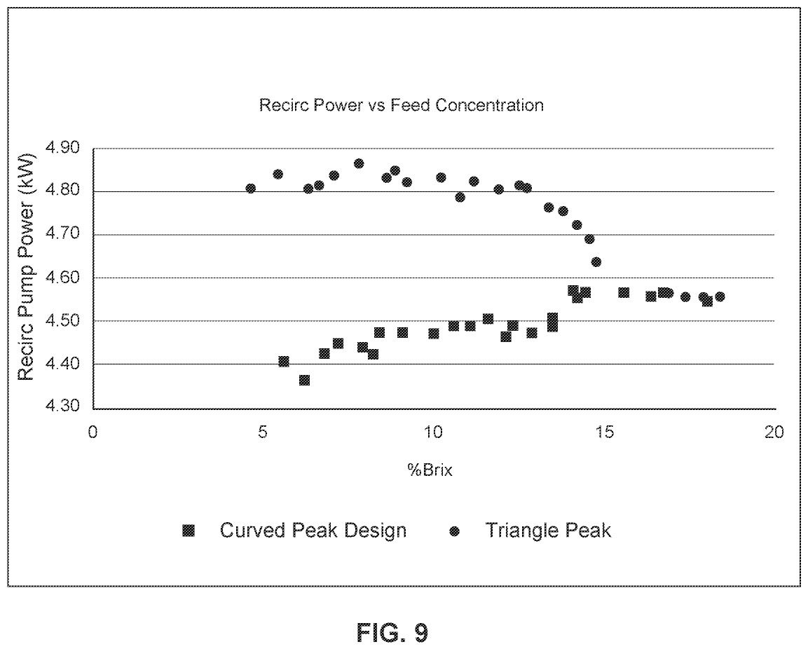

FIG. 9 provides a graph of recirculation pump power in kW to % Brix of the feed solution as it was concentrated up, for each of the triangle peak sleeve and the curved peak design by-pass shell described above. Below 14.5% Brix, the graph shows a significant improvement in flow rate (and accordingly power usage) using the curved peak design by-pass shell as compared to the triangle peak sleeve. Over 14.5% Brix, the improvements are less significant but nevertheless provide a slight improvement over the triangle peak design.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art.

1. A by-pass control sleeve for a spiral wound membrane element, the by-pass control sleeve comprising one or more of:
a. asymmetrical protrusions;
b. protrusions having a steep and/or concave curved forward face; and,
c. protrusions with valleys therebetween, each of the valleys having a width that is in the range of 50-200% of the width of the protrusions,
wherein the protrusions wrap circumferentially around the by-pass control sleeve.

2. The by-pass control sleeve of claim 1 wherein the protrusions wrap circumferentially around the by-pass control sleeve in discrete circles, in a helical pattern or in a spiral pattern.

3. The by-pass control sleeve of claim 1 wherein the width of each of the valleys is 50-200% of the width of the protrusions.

4. The by-pass control sleeve of claim 1 wherein each of the valleys has a constant diameter across its width.

5. The by-pass control sleeve of claim 1 wherein the protrusions having a forward face comprising a concave curve on the upstream side and a rear face comprising a concave curve on a downstream side.

6. The by-pass control sleeve of claim 1 having asymmetrical protrusions.

7. The by-pass control sleeve of claim 1 wherein the forward face of the protrusion is configured to radially deflect feed flow in a direction normal to the circumference of the sleeve.

8. The by-pass control sleeve of claim 1 wherein adjacent ridges have a peak-to-peak distance between about 0.2 cm and 1.6 cm.

9. The by-pass control sleeve of claim 1 wherein the valleys have a depth of between about 0.02 cm and 0.3 cm.

10. A combination comprising the by-pass control sleeve of claim 1 fixed onto the membrane element, and installed within a pressurized vessel.

11. The combination of claim 10 comprising a space of between about 0.02 cm and 0.2 cm between peaks of the protrusions of the by-pass control sleeve and an inside wall of the pressurized vessel.

12. The combination of claim 10 comprising a space between peaks of the protrusions of the by-pass control sleeve and an inside wall of the pressurized vessel of 0.01-0.03 inches.

13. A method of installing a by-pass control sleeve according to claim 1 comprising sliding the sleeve onto an end of the spiral wound membrane element.

14. The method of claim 13 comprising heating the by-pass control sleeve before sliding the sleeve onto the end of the spiral wound membrane element.

15. The method of claim 13 comprising stretching the by-pass control sleeve while sliding the sleeve onto the end of the spiral wound membrane element and releasing the sleeve to elastically contract after sliding over the end of the element.

16. The method of claim 13 wherein the by-pass control sleeve comprises a heat shrink material, comprising heating the sleeve after sliding the sleeve onto the end of the spiral wound membrane element.

17. The method of claim 13 wherein sliding the sleeve onto an end of the spiral wound membrane element comprises sliding the sleeve to a position along the length of the spiral wound membrane element.

18. A method of making a by-pass control sleeve comprising molding protrusions on an outer face of the sleeve, the protrusions each having a forward face comprising a concave curve and/or the protrusions being asymmetrical.

19. The method of claim 18 wherein the by-pass control sleeve is molded before being fixed to a spiral wound membrane element.
